(19) United States
(12) Patent Application Publication
(10) Pub. No.: US 2008/0162278 A1
(43) Pub. Date: Jul. 3, 2008

(54) SYSTEMS AND METHODS FOR PROVIDING BUSINESS RATINGS IN AN E-COMMERCE MARKETPLACE

(75) Inventors: Barak Hershkovitz, Even Yehuda (IL); Jason Wolf, Cupertino, CA (US); Gadi Shamia, Los Altos, CA (US); Gilad Parann-Nissany, Ramat Hasharon (IL)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/618,783

(22) Filed: Dec. 30, 2006

(51) Int. Cl. G06Q 30/00

(52) U.S. Cl. 705/14

(57) ABSTRACT

There are provided methods and system for providing business ratings in an e-commerce marketplace. For example, in one embodiment, there is provided a computerized method including compiling a plurality of business attributes associated with a business entity to create a business profile for the business entity, compiling transaction information associated with the business entity to create a business grading for the business entity, identifying a match between the business entity and a service provider based on the business profile and the business grading of the retailer, publishing the match to the retailer, and initiating a business relationship between the business entity and the service provider.

### TECHNICAL FIELD

This disclosure relates to computer systems and methods, and more particularly, to systems and methods for providing business ratings between businesses using computer applications.

### BACKGROUND

As most people are aware, e-commerce is a large and growing portion of the world economy. Unlike traditional brick and mortar stores, e-commerce systems connect buyers to sellers through computer networks, such as the Internet. E-commerce systems typically provide a virtual “storefront” of a seller's merchandise. Potential buyers can view the seller's merchandise on their computer, and, if they desire, the buyer can order the merchandise from the seller. Advantageously, potential buyers can view the seller's merchandise at any hour of the day, because purchases in e-commerce systems are received by computers.

### SUMMARY

The disclosure provides various embodiments of systems, methods, and software for presenting, managing and/or otherwise facilitating business relationships between retailer and service providers, such as supplier, banks, and so forth. In one embodiment, there is provided a computerized method for providing business ratings between businesses in a marketplace, the method includes compiling a plurality of business attributes associated with a business entity to create a business profile for the business entity, compiling transaction information associated with the business entity to create a business grading for the business entity, identifying a match between the business entity and a service provider based at least partially on the business profile and the business grading of the retailer, publishing the match, and initiating a business relationship between the business entity and the service provider.

In another aspect of the disclosure, there is provided a computerized method for facilitating relationships in an e-commerce marketplace, the method including maintaining a business rating for a marketplace player, wherein the business rating is based on objective information compiled from transactions involving the marketplace player in the e-commerce marketplace, and providing the business rating to a requestor interested in a business relationship with the marketplace player.

In still another aspect of the disclosure, there is provided a computerized method comprising collecting objective transaction information from one or more transactions associated with a business entity in a marketplace, and creating a business rating for the business entity based on at least partially on the collected transaction information.

In still another aspect of the disclosure, there is provided a computerized method including receiving a service request from a retailer, accessing a business rating for the retailer, identifying a service provider associated with the service request, and communicating the service request and the business rating to the service provider, wherein the business rating is based on objective information compiled from transactions in the e-commerce marketplace involving the retailer.

In still another aspect of the disclosure, there is provided a tangible computer readable medium storing code adapted to receive a financing request associated with a business entity, code adapted to determine a term for the financing request based on a business rating for the business entity, wherein the term is at least partially based on objective transaction data for the business entity, and code adapted to communicate the term to the business entity.

The details of these and other aspects and embodiments of the disclosure are set forth in the accompanying drawings and the description below. Features, objects, and advantages of the various embodiments will be apparent from the description and drawings, and from the claims.

### DESCRIPTION OF DRAWINGS

FIG. 1 illustrates an architectural view of an exemplary e-commerce marketplace in accordance with one embodiment of the present invention;

FIG. 2 illustrates an example e-commerce system in according with one embodiment of the marketplace of FIG. 1;

FIG. 3 is a flow chart illustrating an exemplary method for suggesting new products to a retailer in accordance with one embodiment;

FIG. 4 is a flow chart illustrating an exemplary method for creating a master catalog in accordance with one embodiment;

FIG. 5 is a flow chart illustrating an exemplary method that may be employed by one of the marketplace players to access a master catalog in accordance with one embodiment;

FIG. 6 is a flow chart illustrating an exemplary method for providing virtual consignment services in accordance with one embodiment;

FIG. 7 is a flow chart illustrating an exemplary method for fulfilling a virtual consignment order in accordance with one embodiment;

FIG. 8 is a flow chart illustrating an exemplary method for automatically managing retailer inventory in accordance with one embodiment;

FIG. 9 is a flow chart illustrating an another exemplary method for automatically managing retailer inventory in accordance with one embodiment;

FIG. 10 is a flow chart illustrating an exemplary method for creating and/or updating business ratings in accordance with one embodiment;

FIG. 11 is a flowchart illustrating an exemplary method for employing a business rating in a business transaction in accordance with one embodiment;

FIG. 12 is a flow chart illustrating an exemplary method for determining financing terms for a retailer in accordance with one embodiment;

FIG. 13 is a flow chart illustrating an exemplary method for employing business ratings in service provider selections in accordance with one embodiment; and

FIG. 14 is a flow chart illustrating an exemplary method for providing business rating based advertisements in accordance with one embodiment.

### DETAILED DESCRIPTION

As set forth in more detail below, one or more of the embodiments set forth below are directed to systems and methods for facilitating relationships in an e-commerce marketplace. For example, in one configuration, there is provided a computerized method that includes: (1) compiling a plurality of business attributes associated with a business entity to create a business profile for the business entity; (2) compiling transaction information associated with the business entity to create a business grading for the business entity; (3) identifying a match between the business entity and a service provider; such as a supplier or bank, based on the business profile and the business grading; (4) publishing and/or advertising the match to the retailer; and (5) initiating a business relationship between the business entity and the service provider.

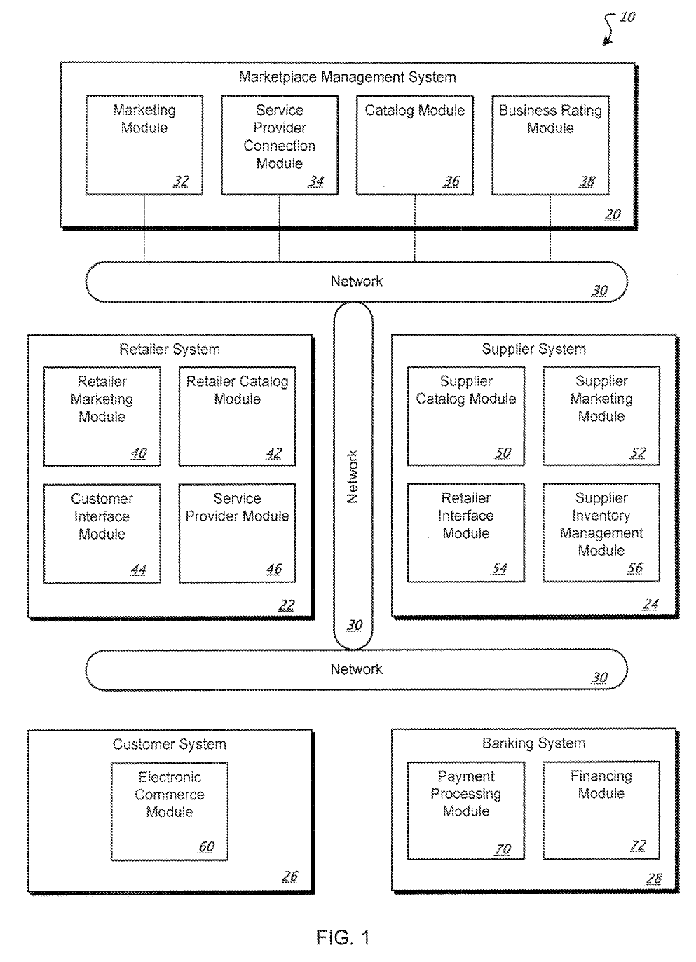

FIG. 1 illustrates an architectural view of an exemplary e-commerce marketplace 10 in accordance with one embodiment. As will be described further below, the marketplace 10 may include one or more systems or modules configured to manage, build, or develop relationships between retailers, their customers (e.g., a consumer) and their service providers, such as suppliers and financial institutions. For example, the marketplace 10 provides numerous new capabilities to the retailer for their transactions with their service providers.

The e-commerce marketplace 10 illustrated in FIG. 1, provides a complete e-commerce based system for managing relationships and transactions between retailers and their service providers. For example, amongst other features, the marketplace 10 may aggregate and analyze purchase data from numerous retailers and suppliers to generate purchase trends that can be used to suggest new relationships between retailers and suppliers. The marketplace 10 may also encourage new relationships between retailers and suppliers by aggregating products from multiple suppliers into a single unified catalog, which can be searched by retailers to locate suppliers as well as by customers (if desired) to locate retailers for a product. Additionally, the marketplace 10 may streamline relationships between retailers and suppliers by offering automated inventory management and/or virtual consignment services. Further, because the marketplace 10 may also include an integrated banking system, the marketplace 10 may reduce transaction costs between retailers and suppliers, many of whom still rely on paper checks or high-fee credit cards to finance purchases.

The marketplace 10 may monitor transactions between businesses in the marketplace 10 and use this information (amongst other factors) to generate business ratings for the businesses. Because these ratings are based on a potential supplier's and/or retailer's actual business history, they may be used by retailers and/or suppliers in the marketplace 10 as a basis for selecting an otherwise unknown retailer or supplier to create a relationship. The business ratings may also be employed by financial institutions, such as banks and/or suppliers as a basis for providing credit to a retailer or supplier.

Referring now to the illustrated FIG. 1, the marketplace 10 may include a marketplace management system 20 and one or more marketplace players, such as a retailer system 22, a supplier system 24, a customer system 26, and a banking system 28. In one embodiment, the marketplace 10 may be a managed marketplace in which the marketplace players 22-28 are granted access to the marketplace 10, and the system 20 manages the interaction of the marketplace players 22-28. In this embodiment, each of the marketplace players 22-28 may be looked upon as “members” of the marketplace 10. For example, the system 20 may host the marketplace 10 and the marketplace players 22-28 may log into the marketplace 10 with a login from the internet or other suitable connection. In other embodiments, however, the marketplace 10 may be a publicly available marketplace, such as the internet.

The marketplace players will also be referred to herein as the retailer 22, the supplier 24, the customer 26, and the bank 28, respectively. As shown, the marketplace management system 20, the retailer system 22, the supplier system 24, the customer system 26, and/or the banking system 28 may be interconnected with each other via a network 30, such as the internet. Although the marketplace 10 is illustrated as including a single instance of the system 20 and each of the marketplace players 22-28, it will be appreciated that this singularity is for illustrative purposes only. As such, in alternate embodiments, the marketplace 10 may include any one of a suitable number of these systems. For example, the marketplace 10 may include several hundred retailers 22 and several hundred suppliers 24.

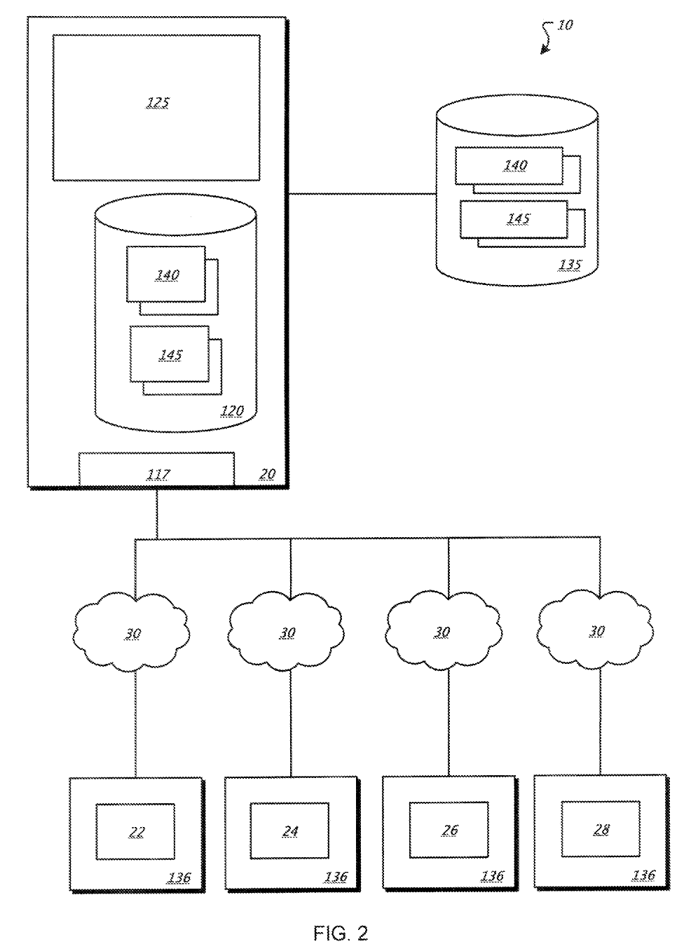

Looking first at the marketplace management system 20, the system 20 may include a marketing module 32, a service provider connection module 34, a catalog module 36, and/or a business rating module 38. In various embodiments, one of which is described in more detail below with regard to FIG. 2, the modules 32-38 may include any suitable form of hardware, software, firmware, and/or combination of hardware, software, and firmware. For example, in one embodiment, the modules 32-38 are computer executable code stored on a computer readable medium, such as a computer memory of storage disk.

As will be described further below, the marketing module 32 may collect and analyze purchase history information (purchase trends) from transactions within the entire marketplace 10 and to match retailers to service provides based upon a retailer's own purchase history, the purchase trends, business profiles, business gradings, and/or any other suitable business trait. Once a match is discovered, the marketing module may encourage a relationship between the retailer and the service provider by sending advertisements to the retailer 22 for the service provider's goods or services.

Once a relationship is established, the service provider connection module 34 may manage the relationship between the retailer 22 and that service provider. For example, as described in more detail below, the service provider connection module 34 may automatically manage inventory relationships between the retailer 22 and the supplier 24 and/or to create and manage a virtual consignment between the retailer 22 and the supplier 24. Moreover, the service provider connection module 34 may also manage connections between the retailer 22, the supplier 24, and the bank 28 to enable payment and routing of funds involved in transactions between the retailer 22 and the supplier 24. Further, the service provider connection module 34 may also manage financial transactions (e.g., loans) to the retailer 22.

The catalog module 36 may populate and maintain a master catalog including entries from multiple suppliers 24 in the marketplace 10. This master catalog may provide a centralized resource for the retailers 22 in the marketplace 10 to consult when looking for new products to sell or new suppliers 24 to provide their existing product lines. In addition, as described in more detail below, the catalog module 36 may also be configured to use the master catalog to identify potential matches between retailers and suppliers. Participation in the master catalog, however, may be optional for the suppliers 24. Moreover, in one embodiment, the customer 26 may also be given access to the master catalog—typically without prices—to enable the customer 26 to locate products that they may wish to purchase. If the customer 26 identifies a product that they wish to purchase, the catalog module 36 may direct the customer 26 to the retailer 22.

The marketplace management system 20 may also include the business rating module 38. As briefly mentioned above, and as described in greater detail below, the business rating module 38 may generate ratings for the retailer 22 and/or the supplier 24 that can be employed by other participants in the marketplace 10 in deciding whether to form new relationships. In other words, the business rating provides an indication of reliability for the business. In one embodiment, the business rating module 38 is configured to create these ratings based at least partially upon objective transaction history data taken from actual transactions within the marketplace 10. In addition, the business rating module 38 may also create and maintain a business profile for each of the marketplace players 22-28. This business profile includes a collection of business attributes, such as business type, business products, business size, location, business history, and so forth.

Turning next to the retailer system 22, the retailer system 22, like the marketplace management system 20, may include a plurality of modules composed of hardware, software, firmware, or a combination of hardware, software, and firmware. For example, the retailer system 22 may include a retailer marketing module 40. The retailer marketing module 40 may interact with the marketing module 32 of the marketplace management system 20 to receive advertisements or other sponsored content for display on the retailer system 22. For example, the retailer marketing module 40 may receive an advertisement from the marketing module 32 based upon purchase trend information compiled by the marketing module 32.

The retailer system 22 may also include a retailer catalog module 42 that is configured to interact with the catalog module 36 of the marketplace management system 20. For example, the retailer catalog module 42 may enable the retailer system 22 to view entries in the master catalog and to contact suppliers 24 corresponding to those entries. The retailer catalog module 42 may further enable the retailer system 22 to designate products within the master catalog that are carried by the retailer system 22, such that the catalog module 36 is able to refer customers 26 to the retailer 22 from the master catalog.

As shown in FIG. 1, the retailer system 22 may also include a customer interface module 44. In various embodiments, the customer interface module 44 may generate any one of a number of suitable e-commerce interfaces from the customer system 26. For example, the customer interface module 44 may generate a website, an e-commerce storefront, a blog, and so forth. Further, as will be appreciated by those of ordinary skill in the art, the customer interface module 44 may create this e-commerce interface either directly on the retailer system 22 or through an e-commerce intermediary, such as an auction site (e.g., EBAY, UBID, etc.), an e-commerce provider (YAHOO MARKETPLACE, FROOGLE, etc.), or any other suitable form of internet interface.

Lastly, the retailer system 22 may include a service provider interface module 46. The service provider interface module 46 may manage the retailer system's interaction with the supplier system 24 and/or the banking system 28. In particular, in one configuration, the service provider interface module 46 may manage retailer inventory for the retailer system 22. For example, as will be described further below, the service provider interface module 46 may establish virtual consignment of products between the supplier 24 and the retailer 22. Further, the service provider interface module 46 may monitor inventory levels for the retailer 22 and to automatically notify the marketplace management system 20 if inventory levels for a particular product drop below a threshold such that the system 20 can automatically generate a purchase order for the retailer 22. In still other configurations, the service provider interface module 46 may enable the retailer system 22 to communicate with the banking system 28 to initiate electronic payments to the supplier 24, to apply for credit from the bank 28, and/or to receive funds from other marketplace players 22-28.

As shown, the supplier system 24 also includes a plurality of modules formed from software, hardware, firmware, or a combination of software, hardware, and/or firmware. First, the supplier system 24 may include a supplier catalog module 50 that may communicate the supplier's inventory to the catalog module 36 of the marketplace management system 20 for publication in the master catalog. It will be appreciated, however, that in some embodiments, the supplier catalog module 50 may be absent or may communicate only a subset of the supplier's inventory to the catalog module 36. The supplier system 24 may also include a supplier marketing module 52. The supplier marketing module 52 may interact with the marketing module 32 within the system 20 to request the display of sponsored content on the retailer 22.

Next, the supplier system 24 may include a retailer interface module 52. The retailer interface module 54 may provide an interface for the retailer 22 to use to order goods from the supplier 24, to establish consignment relationships, and/or to otherwise communicate with the supplier system 24. For example, the retailer interface module 54 may receive requests from the retailers 24 to establish a consignment relationship with the supplier system 24. Further, the retailer interface module 54 may generate purchase orders or other suitable requests for the retailer 22. Lastly, the supplier system 24 may include a supplier inventory management module 56 that may manage the supplier's inventory. For example, the supplier inventory management module 56 may verify the supplier's inventory prior to the retailer interface module 54 establishing purchase or consignment relationships with the retailer 22. Further, the supplier inventory management module 56 may receive consignment sales from the retailer 22 and to initiate dropship shipment of the consigned product directly to the customer 26.

Next, as illustrated in FIG. 1, the marketplace 10 may include the customer system 26. As shown, the customer system 26 may include an electronic commerce module 60 that may link the customer system 26 via the network 30 to the marketplace management system 20 and/or the retailer 22, as appropriate. In one embodiment, the customer system 26 may be a customer configured to browse the world-wide-web. Additional embodiments of the customer 26 will be discussed further below with regard to FIG. 2.

Lastly, the marketplace 10 may include the banking system 28. As shown, the banking system 28 may include a payment processing module 70 and/or a financing module 72. As with the modules discussed above, the module 70 and 72 may be hardware, software, firmware, or a combination of hardware, software, and/or firmware. The payment processing module 70 may enable monetary transactions between the retailer 22, the supplier 24, and/or the owners of the marketplace management system 20. Because the payment processing module 70 is a part of the marketplace 10, the payment processing module 70 may enable electronic transfers of funds between members of the marketplace 10 without the transaction cost or fees that typically accompany conventional payment systems, such as paper checks, credit cards, PAYPAL, and the like.

The financing module 72 of the banking system 28 may interact with the service provider interface module of the retailer system 22 to enable the retailer to apply for credit (e.g., a loan). For example, in one embodiment, the financing module 72 may receive a rating for the retailer 22 from the business rating module 38. The financing module 72 may then use this rating (amongst other features) as a basis for approving a loan, selecting an interest rate for a loan, assessing fees, and so forth.

FIG. 2 illustrates an example e-commerce system 100 in accordance with one embodiment of the marketplace of FIG. 1. The system 100 may include the marketplace management system 20. In one embodiment, the system 20 may be a server coupled to one or more clients, such as the illustrated retailers 22, supplier 24, customer 26, and/or bank 28, at least some of which communicating across network 30. In this embodiment, the system 20 includes an electronic computing device operable to receive, transmit, process and store data associated with system 100. It will be appreciated that FIG. 2 provides merely one example of customers that may be used with the disclosure, and, as such, each illustrated computer (20-28) is generally intended to encompass any suitable processing device. For example, although FIG. 2 illustrates one server (the system 20), the system 100 can be implemented using computers other than servers, as well as a server pool. Indeed, the system 20 may be any computer or processing device such as, for example, a blade server, general-purpose personal computer (“PC”), Macintosh, workstation, Unix-based computer, or any other suitable device. In other words, the present disclosure contemplates computers other than general purpose computers including computers without conventional operating systems. The system 20 may be adapted to execute any operating system including Linux, UNIX, Window Server, or any other suitable operating system. According to one embodiment, the system 20 may also include or be communicably coupled with a web server and/or a mail server.

As illustrated, the system 20 may be communicably coupled with a remote repository 135. The repository 135 may include one ore more persistent storage devices (e.g., hard drives, etc) that form a storage backbone for the system 20. The repository 135 may include any intra-enterprise, inter-enterprise, regional, nationwide, or substantially national electronic storage facility, data processing center, or archive. In another embodiment, the repository 135 may include one or more hard disk drives, semiconductor memories, and the like that are coupled, either internally or externally, to the system 20 via a direct connection, such as an integrated drive electronics (“IDE”) connection, a small computer systems interface (“SCSI”) connection, a Serial ATA (“SATA”) connection, or other suitable communicable connection.

The repository 135 may be a central database communicably coupled to the system 20 via a virtual private network (“VPN”), Secure Shell (“SSH”) tunnel, or other secure network connection. The repository 135 may be physically or logically located at any appropriate location including in one of the example enterprises or off-shore, so long as it remains operable to store information associated with system 100 and communicate such data to the system 20. For example, the repository 135 may comprise a data store or warehouse.

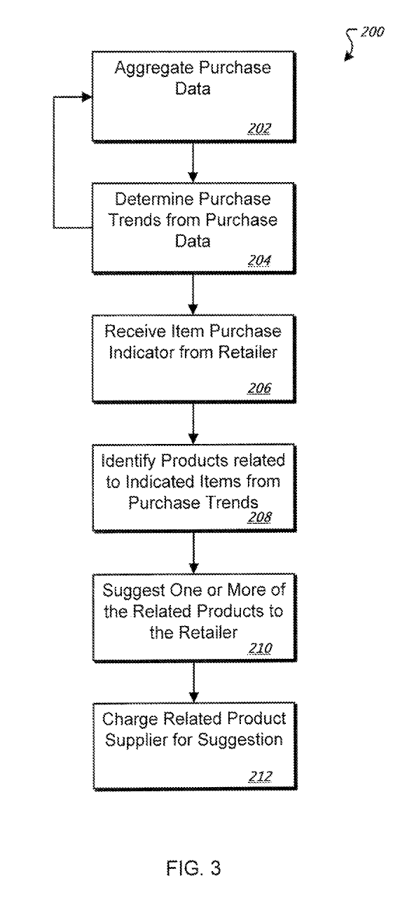

The repository 135 allows for the system 20 and/or one or more the marketplace players 22-28 to dynamically store and retrieve instructions 140 or data 145 from the repository 135. The instructions 140 may include software code or other computer readable instructions that can be executed by one of the marketplace players 20-28 to generate one or more of the modules described above with regard to FIG. 1 or to execute one of the methods described with regard to FIGS. 3-14. For example, the instructions 140 may include code that when executed by the system 20 generate one of the modules 32-38. The instructions 140 may include code that is web-executable (e.g., java code) over the network 30. For example, the retailers system 22 may execute code from the instructions 140 over the network 30 to generate the service provider interface module 46 on the retailer system 22.

The instructions 140 may include software, firmware, wired or programmed hardware, or any combination thereof as appropriate. Indeed, the instructions 140 may be written or described in any appropriate computer language including C, C++, Java, J#, Visual Basic, assembler, Perl, any suitable version of 4GL, as well as others. For example, the instructions 140 may be implemented as Enterprise Java Beans (“EJBs”) or the design-time components may have the ability to generate run-time implementations into different platforms, such as J2EE (Java 2 Platform, Enterprise Edition), ABAP (Advanced Business Application Programming) objects, or Microsoft's .NET. Further, while illustrated as being internal to the repository 135 and/or the system 20, one or more processes associated with the instructions 140 may be stored, referenced, or executed remotely. For example, a portion of instructions 140 may create a web service that is remotely called (e.g., by the retailer system 22), while another portion of instructions 140 may be an interface object bundled for processing at a client (e.g., one of the marketplace players 22-28). In another example, the majority of the instructions 140 may also reside—or their processing take place—on one of the marketplace players 22-28. Moreover, the instructions 140 may be a child or sub-module of another software module or enterprise application (not illustrated) without departing from the scope of this disclosure.

The repository 135 may store also store data 145. The data 145 may include any business, enterprise, application or other transaction data and metadata involving the marketplace players 22-28. For example, the data 145 may include purchase histories, purchase trend information, entries in the master catalog, business profiles, other business attributes, and/or the business ratings, as described above, as well as other suitable marketplace related data. As such, the system 20 may mine the repository 135 for the information needed used identify matches (i.e., new potential relationships) between the marketplace players 22-28.

The system 20 may also include a processor 125. The processor 125 executes instructions, such as the instructions 140 and manipulates the data 145 to perform the operations of the system 20. In various configurations, the processor 125 may be, for example, a central processing unit (“CPU”), a blade, an application specific integrated circuit (“ASIC”), a field-programmable gate array (“FPGA”), or other suitable logic device. Although FIG. 2 illustrates a single processor 125 in system 20, multiple processors 125 may be used according to particular needs and reference to processor 125 is meant to include multiple processor 125 were applicable.

The system 20 also includes local memory 120. As illustrated, the memory 120 may include a subset of the instructions 140 and the data 145. As those of ordinary skill in the art will appreciate, the instructions 140 and data 145 may be copied over to the memory prior to being executed or manipulated by the processor 125. The memory 120 may include any memory or other computer readable storage module and may take the form of volatile or non-volatile memory including, without limitation, magnetic media, optical media, random access memory (“RAM”), read-only memory (“ROM”), removable media, or any other suitable local or remote memory component. The memory 120 may be internally or externally coupled to the system 20.

The system 20 may also include interface 117 for communicating with other computer systems, such as the other marketplace players 22-28, over the network 30. In certain embodiments, the system 20 receives data from internal or external senders through the interface 117 for storage in the memory 120, for storage in repository 135, and/or for processing by processor 125. Generally, the interface 117 comprises logic encoded in software and/or hardware in a suitable combination and operable to communicate with network 30. More specifically, the interface 117 may comprise software supporting one or more communications protocols associated with the network 30 or hardware operable to communicate physical signals.

The network 30 facilitates wireless or wireline communication between the system 20 and any other local or remote computer, such as the marketplace players 22-28. The network 30 may be all or a portion of an enterprise or secured network. In another example, network 30 may be a VPN merely between one or more of the marketplace players 22-28 across a wireline or wireless link. Such an example wireless link may be via 802.11a, 802.11b, 802.11g, 802.11n, 802.20, WiMax, and many others. While illustrated as a single or continuous network, network 30 may be logically divided into various sub-nets or virtual networks without departing from the scope of this disclosure, so long as at least portion of network 30 may facilitate communications between system 20 and at least one of the marketplace players 22-28.

The network 30 encompasses any internal or external network, networks, sub-network, or combination thereof operable to facilitate communications between various computing components in system 100. Network 30 may communicate, for example, Internet Protocol (“IP”) packets, Frame Relay frames, Asynchronous Transfer Mode (“ATM”) cells, voice, video, data, and other suitable information between network addresses. Network 30 may include one or more local area networks (“LANs”), radio access networks (“RANs”), metropolitan area networks (“MANs”), wide area networks (“WANs”), all or a portion of the global computer network known as the Internet, and/or any other communication system or systems at one or more locations. In certain embodiments, network 30 may be a secure network associated with the enterprise and certain local or remote clients.

The retailer system 22, the supplier system 24, the customer system 26, and the banking system 28 may include any computing device operable to connect or communicate with the system 20 or the network 30 using any communication link. At a high level, each of the marketplace players 22-28 may include or execute at least a graphical user interface (“GUT”) 136 and comprise an electronic computing device operable to receive, transmit, process and store any appropriate data associated with system 100. For ease of illustration, each of the marketplace players 22-28 are described in terms of being used by one user. But this disclosure contemplates that many users may use one computer or that one user may use multiple computers. In certain situations, users may include owners, bookkeepers, as well as third party or outside accountants.

The GUI 136 comprises a graphical user interface operable to allow the user of client 104 to interface with at least a portion of system 100 for any suitable purpose, such as viewing application or other transaction data. Generally, GUI 136 provides the particular user with an efficient and user-friendly presentation of data provided by or communicated within system 100. The GUI 136 may comprise a plurality of customizable frames or views having interactive fields, pull-down lists, and buttons operated by the user. For example, the GUI 136 is operable to display certain elements generated by or employed by one or more of the modules described in FIG. 1. The GUI 136 may also present a plurality of portals or dashboards. For example, GUI 136 may display a portal that allows users to view, create, and manage relationships amongst the system 20 and the marketplace players 22-28. It will be understood, however, that the GUI 136 contemplates any graphical user interface, such as a generic web browser or touchscreen, that processes information in system 100 and efficiently presents the results to the user. The GUI 136 can accept data from the system 20 or the marketplace players 22-28 via the web browser (e.g., Microsoft Internet Explorer or Netscape Navigator) and return the appropriate HTML or XML responses using network 30.

As described above, in one embodiment, the system 100 may determine purchase trends from transactions within the marketplace and to suggest new products to the retailer 22 based on those purchase rend and the retailer's purchases. In this way, the marketplace 10 is able to create new relationships between retailer and suppliers, as the suggested products may come from new suppliers. For example, FIG. 3 is a flow chart illustrating an exemplary method 200 for suggesting new products to a retailer in accordance with one embodiment. The method 200 may be performed by the marketing module 32 within the marketplace management system 20. However, it will be appreciated, that in alternate embodiments, other suitable modules or computer systems may execute the method 200.

As illustrated by block 202 of FIG. 3, the method 200 may begin by aggregating purchase data from a plurality of purchase transactions within the marketplace 10 (e.g., the system 100). In one embodiment, the marketing module 32 may monitor purchase transactions between the retailers 22 and the suppliers 24 and to record this transaction history into a database, which may be stored, for example, in the repository 135. More specifically, in this embodiment, the system 20 may store at description (e.g., text description, title, part number, or the like) of each product included in the purchase transactions processed through the system 20. For example, the system 20 may record that a first purchase transaction included twenty bicycles, ten bicycle pumps, and ten global positioning system (“GPS”) units and that second purchase transaction included forty bicycles, twenty bicycle repair kits, and ten GPS units.

After the purchase data has been aggregated, the method 200 may include determining purchase trends from the purchase data, as indicated in block 204. Anyone of a number of suitable statistical methods may be employed to determine the purchase trends. In one embodiment, the system 20 may determine how often the same two items are purchased within a single transaction. For example, using the exemplary database entries from above, the system 20 may determine that the bicycles are likely to be purchased along with bicycle pumps, bicycle repair kits, and GPS units with GPS units purchased twice as often as the pumps and repair kits. As shown in FIG. 3, the method 200 may continuously loop back to block 202 to aggregate new transactions and update the purchase trends, as new transactions are processed by the system 20. It will be appreciated, however, that in alternate embodiments, other suitable methods may be employed to determine the purchase trends. For example, in one embodiment, the purchase trends may be compiled outside the system 20 and downloaded into the system 20.

Next, the method 200 may include receiving an item purchase indicator from the retailer system 22, as indicated by block 206. In one embodiment, receiving the purchase indicator may involve the system 20 receiving a purchase order for the item from the retailer system 22 to the supplier system 24. It will be appreciated, however, that in alternate embodiments, any suitable action or event indicative of the retailer's desire to purchase an item from the supplier 24 may be employed. After receiving the purchase indicator, the method 200 may involve identifying products related to indicated item based on the purchase trends, as indicated by block 208. Using the example given above, based on a purchase indicator for bicycles, the system 20 would identify bicycle pumps, bicycle repair kits, and GPS units, as related to the indicated items.

After identifying the related products, the method 200 may include suggesting one or more of the related products to the retailer, as indicated by block 210. The system 20 may employ the business profile and/or the business rating of the retailer 22 in determining which products to suggest to the retailer 22. For example, some suppliers 24 may wish to target only retailers of a certain size or retailers in a certain geographic location. Still other suppliers may wish to target only retailers 22 with a particular business rating.

In one embodiment, this suggestion takes the form of an advertisement configured to be displayed on the retailer system 22. Advantageously, as described above, the advertisement may be focused on retailers based on their business profiles and business ratings. In one embodiment, the system 20 may determine when an advertisement is appropriate; whereas in another embodiment, the supplier 24 or other service provider may specify the system the desired business profile and/or business grading required for a match, and, thus, an advertisement. For example, the supplier 24 may specify that their advertisement is only to be sent to retailers with an AAAA rating located with 100 miles of New York City. In this case, the system 20 would only send the advertisement to retailers 22 that met those criteria.

Any suitable form of advertisement may be employed. For example, the suggestion may be included in a purchase order for the item, may be displayed on a check-out screen, may be located in a “pop-up” window, or may employ another suitable advertisement method. Additionally, in some configurations, the suggestion may also include text explaining the relationship between the related products and the item indicated for purchase. For example, with the example given above, the suggestion may state that 50% of the purchase of bicycles also purchased GPS units, and that 25% of bicycle purchasers also pumps or repair kits. In this way, the retailer interested in one product can easily identify related products. Moreover, the suggestion may also include contact information for a supplier (e.g., name, website, etc.).

By identifying new related products to the retailer 22, the method 200 advantageously forges new relationships between retailers and the suppliers of the related products. In addition, as indicated by block 212 of FIG. 3, the owner/provider of the system 20 may benefit from the suggestion by charging the supplier(s) of the related products for communicating the suggestion to the retailer 22. In one embodiment, the system 20 may charge the supplier 24 a few whenever a suggestion is communicated to the retailer 22, whereas in another embodiment, the system 20 may only charge the supplier 24 when the retailer 22 actually makes a purchase from the supplier 24 based on the suggestion. It will be appreciated, however, that these two methods for charging the supplier 24 are not intended to be exclusive. As such, in alternate embodiments, other suitable advertising fee arrangements may be employed. Moreover, in some embodiments, the supplier 24 may not be charged for the suggestion or may be charged a flat fee for the participating in the suggestion service.

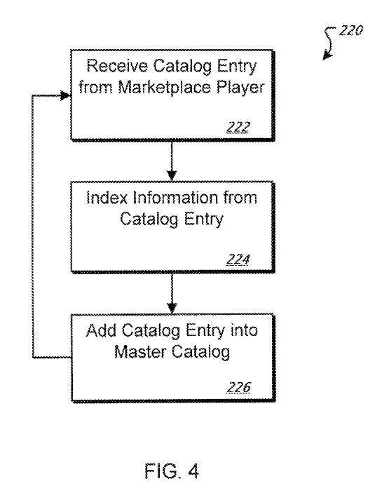

Turning next to FIG. 4, the catalog module 36 may compile and manage a master catalog that may be accessed by the marketplace players 22-28. Accordingly, FIG. 4 is a flow chart illustrating an exemplary method 220 for creating a master catalog in accordance with one embodiment. As described above, the system 20 may create the master catalog, which includes items from a plurality of suppliers. Accordingly, the master catalog may provide a central resource for the marketplace players 22-28 to search for items sold by suppliers in the marketplace 10. In one embodiment, the method 220 may be executed by the marketplace management system 20.

As indicated by block 222 of FIG. 4, the method 220 may begin with the system 20 receiving a catalog entry for an item from one of the marketplace players. Typically, the system 20 will receive catalog entries primarily from the supplier system 24. The catalog entries will include one or more pieces of information related to the item. For example, the entry may include a name for the item, a picture of the item, a price for the item, the supplier's name and contact information, a description for the item, reviews of the item, retailers in the marketplace 10 that sell the item, and/or other suitable information. It will be appreciated, however, that this listing of catalog information is not intended to be exclusive.

After receiving the catalog entry, the method 220 may include indexing the information from the catalog entry, as indicated by block 224. In one embodiment, indexing the information involves identifying one or more of the pieces of information that are relevant to the organization of the master catalog. For example, if the master catalog is sorted by item type and price, indexing the catalog entries may include identifying the item type and the item price. After the information from the catalog entry is indexed, the catalog entry may be added into the master catalog and the method 220 may begin again with another catalog entry, as indicated by block 226 and the arrow from block 226 to block 222. In this way, the master catalog of the system 20 may be created by receiving catalog entries from a plurality of suppliers 24. It will be appreciated, however, that the method 220 is merely one exemplary method for creating the master catalog. As such, in alternate embodiments, other methods for compiling catalog entries from a plurality of suppliers may be employed. For example, in one alternate embodiment, the catalog module 36 may actively search the supplier system 24 for catalog entries or pre-indexed catalog information may be manually uploaded directly into the master catalog.

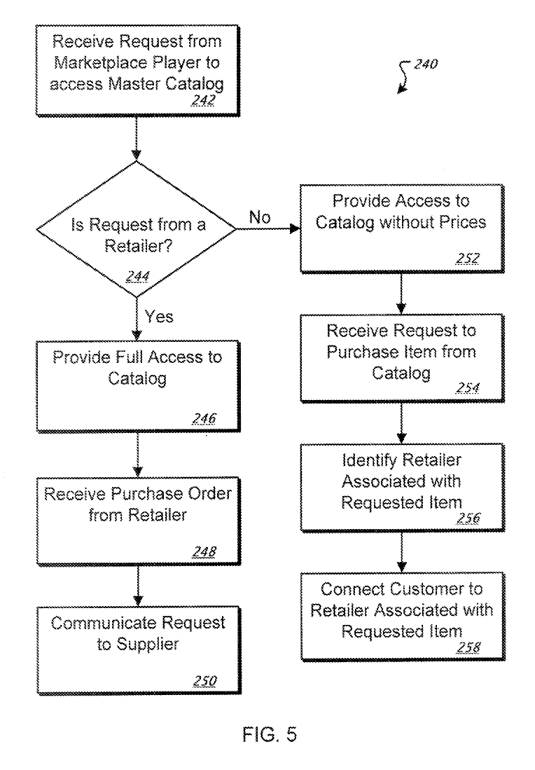

As described above, once the master catalog has been created, it may function as a central resource for the retailers 22 and/or the customers 26 to search for items sold by the suppliers 24. For example, FIG. 5 is a flow chart illustrating an exemplary method 240 that may be employed by one of the marketplace players 22-28 to access the master catalog maintained by the system 20 in accordance with one embodiment. In one configuration, the method 240 is executed by the system 20.

As indicated by block 242, the method 240 may begin with the receipt of a request from one of the marketplace players 22-28 to access the master catalog stored by the system 20. After receiving the request, the method 240 may next involve determining if the request originated from the retailer 22, as indicated by block 244. If the request was generated by the retailer 22, the method 240 may provide full access (unrestricted access) to the master catalog, as indicated by block 246. Next, the method 200 may include receiving a purchase order or request from the retailer for an item from the master catalog (block 248) and communicating the purchase order to the supplier 24 of the item (block 250).

If, on the other hand, the request to access the master catalog did not originate with the retailer 22 (block 244), the method 240 may include providing access to a restricted version of the master catalog that does not include item prices. As those of ordinary skill in the art will appreciate, the typical supplier 24 relies on the retailers 22 to be their main sales force. As such, most suppliers prefer to not sell their products directly to consumers—preferring instead to direct consumers to an authorized retailer of their products. Accordingly, in the illustrated embodiment, the method 240 is designed to withhold items prices from the master catalog to non-retailers. It will be appreciated, however, that the system 20 may be configured (if desired) to display item prices to any of the marketplace players 22-28. Moreover, the system 20 may display item prices for some of the items and not for others.

If a non-retailer wishes to purchase an item from the master catalog (block 254), the method 256 may involve identifying the retailers 22 associated with the item (block 256) and connecting the customer to one of the identified retailer (block 258). In this way, the master catalog may serve not only to connect retailers to suppliers, but also to connect consumers to retailers. Although not illustrated in FIG. 5, it will be appreciated, that the method 240 may also include charging various fees to the supplier 24 and/or the retailer 22 for communicating the purchase order to the supplier 24 (block 250) and for connecting the customer with the retailer 22.

The marketplace management system 20 may also enable the retailer 22 and the supplier 24 to enter into virtual consignment relationships with each other. As those of ordinary skill will appreciate, in traditional (non-virtual) consignment relationships, a consignor may entrust goods to a consignee to sell for them. The consignee may then carry the consigned goods along the consignee's other inventory. When the consigned goods are sold, the consignee pays the consignor some portion of the sales prices and retains the remaining portion of the sales price for themselves.

The system 20 enables virtual consignment between the supplier 24 and the retailer 22. However, because the relationship is virtual, there is no requirement to physically move the goods from the consignor (the supplier) to the consignee (the retailer 24). Rather, the items may be virtually consigned by adding them to the retailer's e-commerce site (e.g., the retailer's website). Then, if the consigned item is purchased from the retailer 22, the supplier 24 can be notified to dropship the item to the customer 26. Advantageously, the system 20 enables the retailer 22 to benefit from advantages of consignment (e.g., profit with having to pay for inventory) while protecting the supplier from the traditional risks of consignment (e.g., having to physically give up control of the inventory).

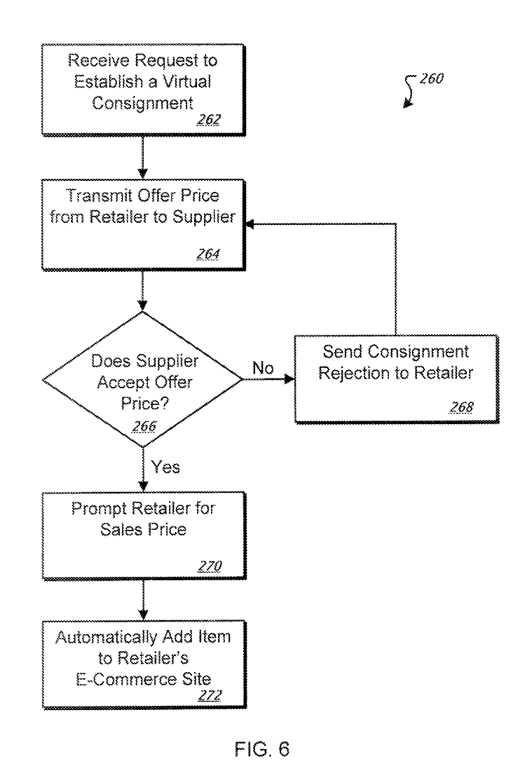

In one embodiment, the system 20 may execute the method 260 illustrated by the flow chart of FIG. 6 to provide virtual consignment services to the retailer 22 and the supplier 24. As shown, the method 260 may begin at block 262 with receiving a request to establish a virtual consignment. The consignment request may also include one of more of the following factors: site rating by the buyers, summary of categories sold in the retailer's site, site consignment volume, consignor's reviews and rating on the site, business attributes/profile of the retailer, and/or business grading of the retailer 22.

This request may be generated by either the retailer 22 or the supplier 24. For example, in one embodiment, a retailer 22 may request to establish a virtual consignment relationship with a supplier 24 after receiving a related product suggestion from the system 20, as described in regard to FIG. 3. In particular, after receiving the product suggestion, the retailer 22 may use the virtual consignment service of the system 20 to “try out” a new product before deciding to add the new product to their inventory. Advantageously, the virtual consignment relationship enables the retailer 22 to judge response to the new product from their customers without the cost of adding the item to their inventory.

After a virtual consignment relationship has been requested, the retailer 22 may transmit an offer price to the supplier 24, as indicated by block 264. It will appreciated, however, that in alternate embodiments, the retailer's offer may also accompany the request to establish a virtual consignment or the supplier 24 (i.e., the consignor) may transmit the offer price to the retailer 22 (i.e., the consignee). After the supplier 24 has decided whether to accept the offer price, the supplier 24 may communicate the decision to the system 20, which in turn communicates the decision to the retailer (block 266). If the decision is negative, the system 20 may notify the retailer 22 of the consignment rejection (block 268), and the method 264 may loop back to block 264 to enable the retailer 22 to make another offer. A similar bid acceptance process may also be used in embodiments where the supplier 24 initiates the offer price.

If the offer price is accepted by the supplier (block 266), the system 270 may prompt the retailer for a sales price for the consigned item, as indicated by block 270. It will be appreciated that the sales price for consigned item is the price that will be listed for the item on the retailer's e-commerce site. Typically, the sales price will be higher than the accepted offer between the retailer 22 and the supplier 24. For example, if the accepted offer price is $300, the retailer 22 may select a sales price of $400—leaving the retailer a $100 profit after the $300 due to the supplier 24 is deducted. It will appreciated, however, that the offer price may include any suitable pricing rules. For example, in one embodiment, the price of the consigned items may changes based on the number of items sold by the retailer. For example, the retailer may receive a discount for volume sales, such as 10 percent discount for selling over five products, a 25 percent discount for selling over 10, and a 35 percent discount for selling over 100 items. In systems that employ this pricing technique or other suitable techniques, the system 20 advantageously tracks the number of sold items and makes the pricing calculations transparent to both the retailer 22 and the supplier 24.

After receiving the sales price for the consigned item, the system 20 may automatically add the consigned item to the retailer's e-commerce site, as indicated by block 272. For example, in one embodiment, the system 20 may automatically add the consigned item to the retailer's website. In one embodiment, the system 20 may automatically create the entries for the consigned item on the retailer's e-commerce site using information from the master catalog. Advantageously, the system 20 enables the retailer 22 to automatically add consigned goods to its e-commerce site while maintaining control of its e-commerce site. In other words, while establishing the virtual consignment relationship, the retailer 22 is never required to grant the supplier control over the retailer's e-commerce site. At the same time, because the system 20 handles the addition, the retailer 22 is not required to do anything other than to approve consignment to make this addition to their e-commerce site. Moreover, because the system 20 may employ the master catalog to create entries on the retailer's site, the supplier 24 can advantageously engage in multiple consignment relationships without having to create custom entries (e.g., html code) for each separate retailer's site. Rather, once the initial catalog information for a product has been programmed, any number of consignments may be established without additional programming. This functionality advantageously enables relatively non-technical business people to engage in virtual consignment relationships.

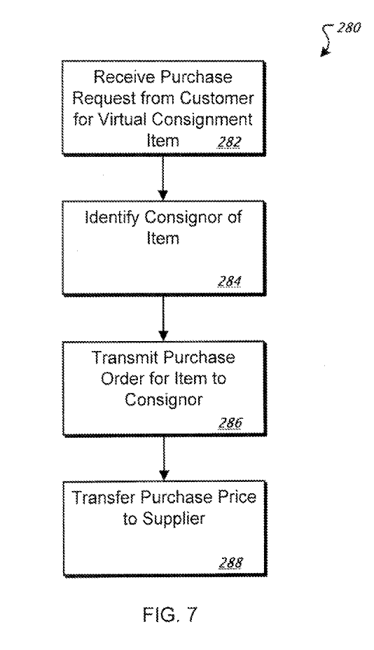

As described above, the system 20 enables virtual consignment relationships to be established between retailers 22 and suppliers 24. In addition, the system 20 may also manage the fulfillment of these virtual consignment orders. For example, FIG. 7 is a flow chart illustrating an exemplary method 280 for fulfilling a virtual consignment order in accordance with one embodiment. In one embodiment, the method 280 may be performed by the service provider connection module 34 of the system 20. However, in alternate embodiments, the method 280 may be performed by other suitable systems, such as the service provider interface module of the retailer system 22.

The method 280 may begin by receiving a purchase request for a consigned item from the customer 26 (block 282). Upon receiving the purchase request, the system 20 may identify the consignor (e.g., the supplier 24) of the consigned item, as indicated by block 284. Next, the system 20 may transmit a purchase order to the consignor, as indicated by block 286. Upon receiving this purchase order, the supplier system 24 may automatically initiate a dropship process for the item. In one embodiment, the method 280 may also include transferring the agreed upon price from the retailer 22 (who received payment from the customer) to the supplier 24. In one embodiment, this transfer may involve the banking system 28. In this way, the system 20 advantageously enables the supplier 24 to automatically initiate shipment of consigned goods without requiring additional steps to be performed by the retailer 22. Further, the system 20 may also enforce my pricing rules regarding the consignment purchase. For example, if the retailer 22 and the supplier 24 had agreed to pricing rule where the price changes based on number of items sold, the system 20 may automatically adjust the payments to each of the parties when sales reach appropriate levels. In this way, the system 20 is able to automatically enforce business agreements between the supplier 24 and the retailer 22 regarding the virtual consignment.

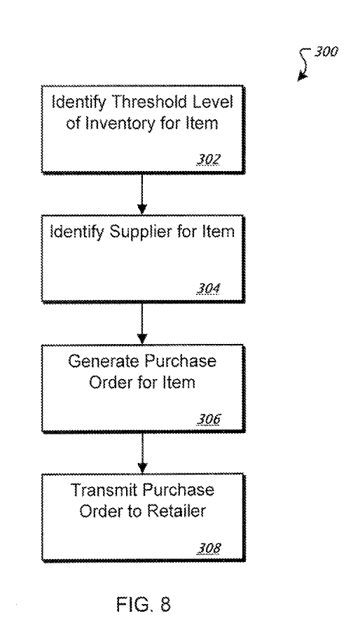

The system 20 may also provide improved inventory management functions for the retailer 22. For example, FIG. 8 is a flow chart illustrating an exemplary method 300 for automatically managing retailer inventory in accordance with one embodiment. In particular, the method 300 enables the system 20 to automatically initiate an order process for the retailer 24 if the retailer's inventory of the item falls below a threshold, which may be set by the retailer 22 or determined by the system 20. In one embodiment, the method 300 may be performed by the system 20.

As indicated by block 302 of FIG. 8, the method 300 may begin by identifying that an inventory level for one of the items in the retailer's inventory has dripped below a threshold level. In other embodiments, the method 300 may begin by identifying an inventory scheduling instance, a number of repeats of an order, or any other suitable inventory management rule or condition. Upon recognizing this condition, the system 20 may identify a previous supplier 24 of the item, as indicated by block 304. Next, the system 20 may automatically generate a purchase order for the item (block 306) and transmit the generated purchase order to the retailer 22 (block 308). In one embodiment, the purchase order may be sent to retailer 22 as an email that the retailer 22 can approve and forward onto the supplier 24. It will be appreciated, however, that blocks 306 and 308 illustrate only one of a number of suitable methods for ordering more items from the supplier 24. Accordingly, in alternate embodiments, other methods may be employed.

As described above, the method 300 of FIG. 8 provides a method for automatically reordering retailer inventory from a previously used supplier. In some situations, however, the retailer 22 may desire to look for a new supplier 24 for the inventory item. For example, the retailer 22 may be dissatisfied with the price of previously purchased item or dissatisfied with the service of the previous supplier. Alternatively, the previous supplier may have stopped carrying the item or may also have gone out of business.

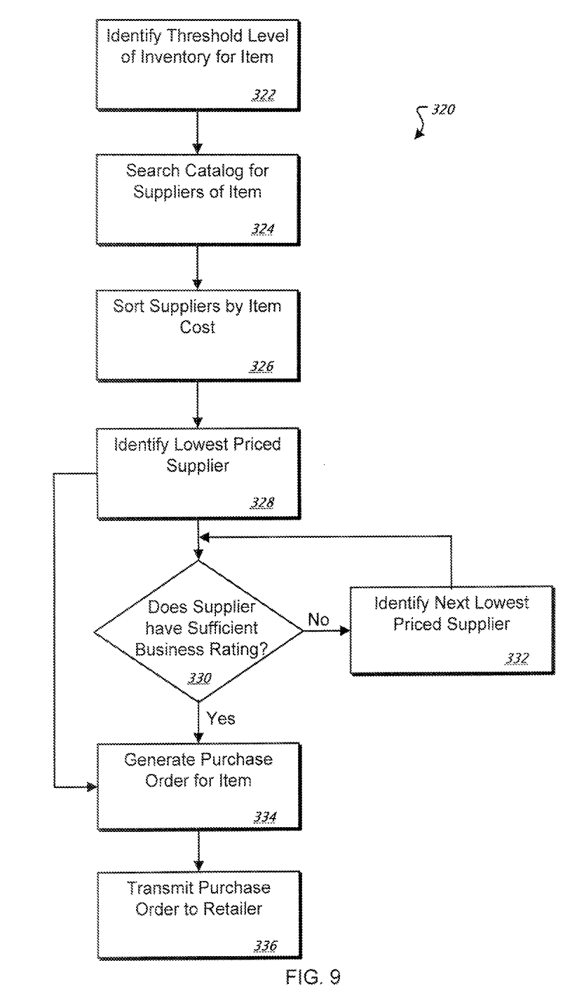

In this situation, the system 20 may execute the method 320 illustrated as a flow chart in FIG. 9 in accordance with one embodiment. As with the method 300 of FIG. 8, the method 320 may begin by identifying that the retailer's inventory level for a particular item has dipped below the threshold level (block 322). After recognizing the inventory level, the method 324 may include searching the master catalog (or other suitable database) for suppliers of the particular item, as indicated by block 324. Next, the method 320 may include sorting the suppliers of the item by a metric, such as item cost (block 326) and identifying the supplier with the lowest price for the item (block 328). It will be appreciated, however, that item cost, while the most typical concern for the retailer 22, may not be the only concern regarding ordering new items. As such, in alternate embodiments, the suppliers of the item may be sorted by other suitable metrics. For example, during the holidays, the retailer 22 may sort the suppliers by delivery time.

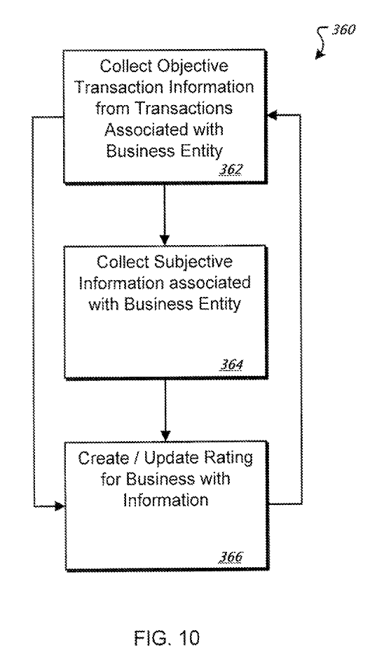

It will be appreciated, however, that the lowest priced supplier (or the fastest supplier, and so forth) may not always be a good choice for the retailer 22. For example, the lowest priced supplier may unreliable, slow, dishonest, etc. For this reason, in one embodiment, the method 320 may also employ the business ratings and/or business profiles. This business rating system may be the business rating system described in more detail below with regard to FIGS. 10-14 or may be another suitable system from rating businesses. However, employing business ratings is not required, and the method 320 may alternatively proceed directly to block 334 after identifying the lowest priced supplier.

If the system 20 does employ business ratings in the method 320, it may next determine whether the supplier 24 with the lowest price for the item (or alternatively, the quickest delivery time, etc.), has a “sufficient” business rating, as indicated by block 330. In one embodiment, the retailer 22 determines what business ratings are “sufficient” for that retailer. For example, if the business rating system employs a scholastic grading system (A, B, C, D, or F), the retailer may set the “sufficient” business rating as a B. As such, only suppliers 24 with a rating of B or higher would be acceptable to the retailer 22. It will be understood, however, that in alternate embodiments, other suitable rating systems may be employed or other suitable “sufficient” levels may be set by the retailer. Moreover, in still other embodiments, the system 20 may determine or recommend the “sufficient” level. In still other embodiments, the system 20 ay also determine if the supplier is sufficient based on the business profile of the supplier 24.

If the lowest priced supplier does not have an acceptable business rating (block 330), the method 320 may identify the next lowest priced supplier (block 332) and loop back to block 330 to check the business rating of the next lowest priced supplier (or next fastest supplier, etc.). In this way, the method 320 may enable the retailer 22 to identify the lowest priced supplier that is also reliable (i.e., has a sufficient business rating, which indicates a history of past reliability). After identifying this supplier, the method 320 may involve generating a purchase order for the desired item (block 334) and transmitting the purchase order to the retailer, as described above with regard to FIG. 8 and as indicated by block 336.

As described above, the system 20 may also create and maintain business ratings (also referred to as business grades) for the marketplace players 22-28. The business ratings produced by the system 20 are at least partially based on the actual transactions from the marketplace 10. Because the system 20 manages the transactions within the marketplace 10 (and is thus privy to all of those transactions), the system 20 can create a business rating that includes an objective rating of reliability based on the marketplace player's actual past actions (e.g., volume, inventory level, cash level, and so forth) in previous transactions—data which is unavailable to conventional rating organizations.

Although the business ratings created by the system 20 may use any suitable rating scheme, in one embodiment, the system 20 may create ratings using a four-part scholastic format (e.g., AAAA, ABCD, etc.). In this embodiment, each of the four parts or “grades” may rate a different aspect of the business relationships of the rated business. For example, the first letter may rate the business's sales volume, the second letter may rate the business's financial management, the third latter may rate the business's inventory and procurement management, and the fourth letter may represent the business's customer service and management.

As described above, one or more aspects of these ratings may be at least partially based on the objective information culled from the business's actual transaction within the marketplace 10. As used herein, “objective” information or criteria refers to factual business data noted based on subjective ratings or reviews. For example, the business's rating for sales volume may be based on the business's actual volume of sales to others within the marketplace and/or the businesses financial management rating may be based upon the amount of money that the business has in the bank 28. It will be appreciated, however, that these two examples of objective rating criteria are not intended to be exclusive, and, as such, other suitable objective criteria from the marketplace 10 may also be employed. Moreover, in some embodiments, the business rating may also be partially based upon non-objective (i.e., opinion based) criteria. For example, in one embodiment, the business's rating for customer service and management may be based on customer satisfaction surveys or another opinion based criteria.

FIG. 10 is a flow chart illustrating an exemplary method 360 for creating and/or updating business ratings in accordance with one embodiment. As illustrated, the method 360 may begin by collecting objective transaction information from transactions associated with the business to be rated (block 362). In one embodiment, the system 20 may record objective data regarding each of the transactions that take place in the marketplace 10. For example, the system 20 may maintain a database of all of the transactions that have taken place within the marketplace 10. This database may include the buyer and seller for each transaction, the items purchased, the amounts of the purchase, the shipping time, the payment time, and so forth. As described above with regard to FIG. 3, the system 20 may also use this database to determine purchase trends.

After collecting objective information regarding the business's transactions, the system 20 may collect subjective (i.e., opinion) information regarding the transactions and/or the business to be rated, as indicated by block 364. In one embodiment, the subjective information is stored in the same database as the objective information and may be accessed in the same manner. However, in other embodiments, the subjective information may be maintained on a separate system in the marketplace 10 or may be downloaded from a source external to the marketplace 10. Further, as indicated by the arrow bypassing block 364, in at least one configuration, the business rating may be based exclusively on objective criteria.

After the rating information has been collected, the system 20 may create the business ratings, as indicated by block 366. Any suitable method may be used to convert the collected information into the business rating. For example, in one embodiment, the rating may be based on the number of data points (e.g., the total number of transactions, the average number of days to ship, and the like) for the business. In one another embodiment, the business rating may be based upon recent activity (e.g., over the past six months, the past year, etc.). The ratings may be based on surpassing a threshold independent of others in the marketplace (e.g., over 100 transactions per month equates to a A+ rating for volume) or may be dependent on the activity of other marketplace players (e.g., being in the top 10% of sellers by volume equates to an A+ rating for volume).

Once the system 20 has created the rating, the method 360 may loop back to block 362 and continue to collect additional transaction information for the business. With this additional information, the system 20 may periodically update the business rating. In this way, the business ratings for the marketplace players 22-28 will reflect the recent activity of the business as well as their business history (if desired).

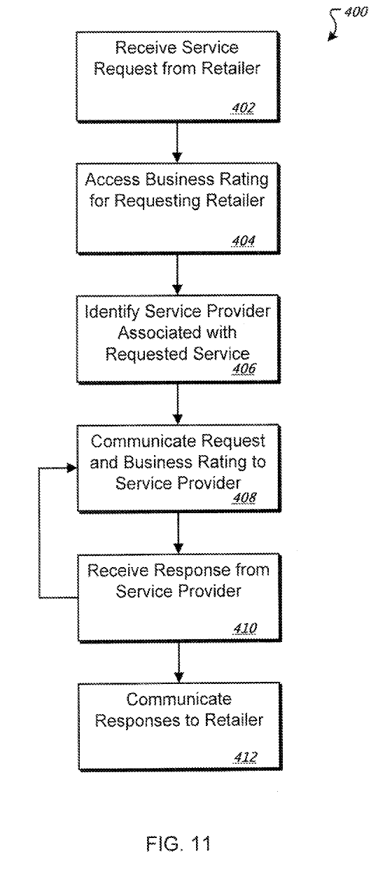

As described above, the business ratings created by the system 20 may be used as an indicia of reliability between the marketplace players 22-28 to foster the creation of new business relationship in the marketplace 10. Accordingly, FIG. 11 is a flowchart illustrating an exemplary method 400 for employing a business rating in a transaction within the marketplace 10 in accordance with one embodiment. The method 400 may be executed by the system 20.

As indicated by block 402 of FIG. 11, the method 400 may begin with the system 20 receiving a service request from the retailer 22. The service request may be for any of the service providers in the marketplace 10. For example, the service request may be purchase order for the supplier 24, a request for a loan from the bank 28, or a request for financing from an investor. After receiving the request from the retailer 22, the system 20 may access the business rating for the requesting retailer, as indicated by block 404. The system 20 may also identify a service provider associated with the requested service. In one embodiment, a preferred service provider may be contained within the request itself. For example, the retailer 22 may pre-select one of the retailers 24. In another embodiment, the system 20 may identify one or more service providers based on the type of service requested. For example, if the requested service is a loan, the system 20 may identify banks that provide loans to retailers.

Next, the system 20 may communicate the service request and the business rating for the retailer 22 to the service provider. For example, if the service is loan, the system 20 may communicate the request for the loan (including information on the retailer 22) to the bank 28 along with the business rating of the retailer 22. At some point after communicating the request to the service provider, the system 20 may receive a response from the service provider. For example, if the service request is a request to purchase an item from the supplier 24, the response may be a sales price. Advantageously, because the service provider is able to consult the business rating for the retailer 22 while making its decision, the decision may be custom-suited to the retailer 22. For example, a retailer with an AAAA rating may receive a lower price quote than a retailer with a CCCB rating. This functionality enables to the service provider to provide more competitive prices to reliable retailers and while charging more to retailers that are less reliable to compensate for the additional risk in dealing with a less reliable retailer.

As indicated by the arrow from block 410 to block 408, the system 20 may communicate the request and the business rating to a plurality of service providers. In this way, the system 20 may be able to present multiple service options to the retailer—allowing the retailer to select amongst them. Accordingly, the method 400 may conclude by communicating the one or more service provider response to the requesting retailer, as indicated by block 412. For example, in one embodiment, the system 20 may transmit a list of service providers along with the response to the retailer's request (e.g., the offered price) and a link to each service provider's e-commerce site.

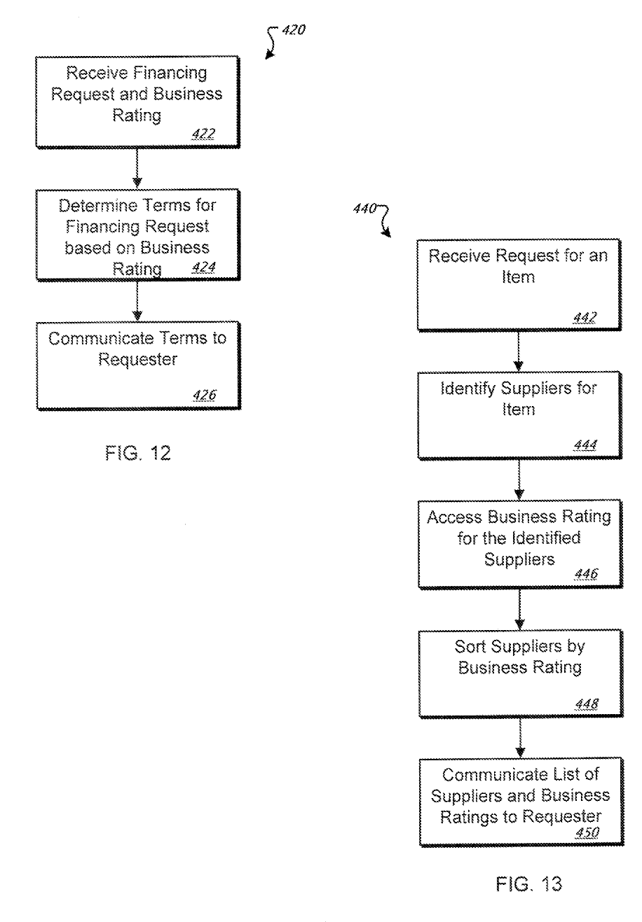

As described above, service providers in the marketplace 10 may use the business rating of the retailer 22 to make pricing decisions for services to the retailer 22. For example, in the case of financial service providers, such as the bank 28, the business rating of the retailer 22 may be employed as criteria in deciding whether to finance the retailer, and/or, if appropriate, what terms would be used for the financing. FIG. 12 is a flow chart illustrating an exemplary method 420 for determining financing terms for a retailer in accordance with one embodiment. The method 420 may be performed by the banking system 28 (e.g., the financing module 72) or another suitable system, such as the supplier system 24, if the request is for financing a purchase from the supplier 24.

The method may begin, as indicated by block 422, with the banking system 28 receiving a financing request and a business rating associated with the retailer 22. Typically, the banking system 28 will receive the request and business rating from the system 20 in order to ensure that the business rating is authentic. After receiving the financing request and the business rating, the banking system 28 may determine terms for the financing request based at least partially on the business rating of the retailer 22, as indicated by block 424. Amongst other things, the determined terms may include whether to offer financing, the interest rate of the financing, the repayment period, any fees incident to the financing, and the like. These exemplary financing terms are not intended to be an exclusive listing of suitable financing terms. After determining the terms, the banking system 28 may communicate the terms back to the requesting retailer, as indicated by block 426. In one embodiment, the banking system 28 may communicate the terms to the system 20, which may interface with the requesting retailer 22. For example, as described above with regard to FIG. 11, the system 20 may send requests and business ratings for the retailer to a plurality of banks 28, and then compile the results for the retailer 22 (e.g., perform a reverse auction for the retailer 22).

As mentioned above, the system 20 may create business ratings for all of the marketplace players—including the service providers, such as the supplier 24 and the bank 28. Accordingly, in the same fashion as the service providers may use the business rating to evaluate potential retailers, the retailers 22 may use the business ratings of the service providers to evaluate potential service providers. FIG. 13 is a flow chart illustrating an exemplary method 440 that may be employed by system 20 to enable the retailer 22 to employ the business ratings in its service provider selections in accordance with one embodiment.

As indicated by block 442 of FIG. 13, the method 440 may begin when the system 20 receives a request for an item from the retailer 442. For example, the system 20 may receive a request for the retailer 22 while the retailer 22 is viewing the master catalog. After receiving the request, the system 20 may identify suppliers for the item (block 444) and access the business ratings for identified suppliers (block 446). Next, the system 20 may sort the suppliers by business rating (block 448) and communicate the sorted list of service providers to the retailer 22 (block 450). In this way, the retailer 22 may use the business rating of each service provider in making a decision whether to enter into a business relationship with the service provider.

As described above, the business rating of a marketplace player 22-28 may provide an indication of the potential reliability and/or financial strength of the marketplace player. As such, in one embodiment, the system 20 may be further configured to target advertising to various market players 22-28 based on their business rating. In other words, the system 20 may provide an advertiser, such as the supplier 24, with advertisements targeted to only those retailers 22 with at least a certain threshold business rating. For example, the advertiser could purchase advertisements to retailers 22 with at least a B rating. Because the functionality focuses advertisements on a subset of more “desirable” retailers (i.e., the supplier's customers), the system 20 may be able to charge more per advertisement for this type of advertisement compared to advertisements that may also be sent to less “desirable” retailers.

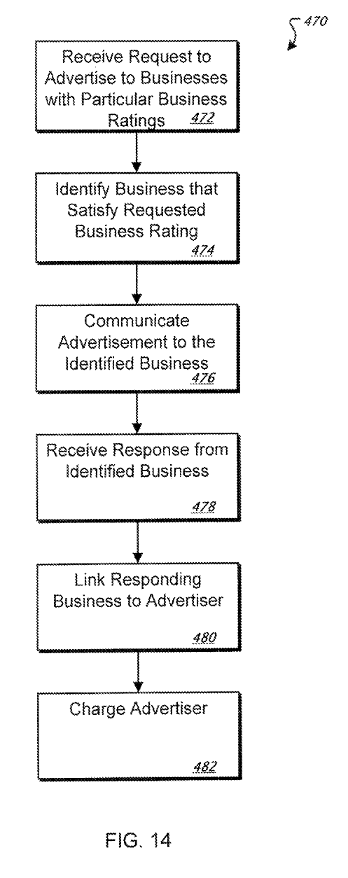

FIG. 14 is a flow chart illustrating an exemplary method 470 for providing business rating based advertisements in accordance with one embodiment. The method 470 may be executed by the system 20 or another suitable computer system. As illustrated, the method 470 may begin with the system 20 receiving a request from an advertiser to advertise to businesses in the marketplace 10 (e.g., the retailers 22) with at least a certain threshold business rating (block 472). Although not required, the advertiser's request may also include other advertising criteria, such as business type, business location, size, or other business attributes.

After receiving the request, the system 20 may identify businesses in the marketplace 10 that meet the requested advertising criteria. For example, if the advertiser requested to advertise to bicycle retailers with at least a B business rating, the system 20 would identify the bicycle retailers in the marketplace 10 that have at least a B rating. Next, the system 10 may transmit the advertisement to one or more of the identified businesses. The advertisements may take the form of pop-up advertisements, banner advertisements, email solicitations, direct mail, or any other suitable form on on-line or off-line advertising. If the system 20 receives a response from the business that received the advertisement (block 478), the system 20 may link the responding business to the advertiser (block 480) and charge the advertiser for the advertisement—if not done previously (block 482). In one embodiment, the system 20 may only charge the advertiser for connections that result in actual transactions (e.g., sales, loans) within the marketplace.

It will be appreciated that the preceding flowchart and accompanying description illustrate exemplary methods. Accordingly, the system 100 described above contemplates using or implementing any suitable method for performing these and other tasks. It will be understood that these methods are for illustration purposes only and that the described or similar methods may be performed at any appropriate time, including concurrently, individually, or in combination. Further, although this disclosure has been described in terms of certain embodiments and generally associated methods, alterations and permutations of these embodiments and methods will be apparent to those skilled in the art. Accordingly, the above description of example embodiments does not define or constrain this disclosure. Other suitable changes, substitutions, and alterations are also possible without departing from the spirit and scope of this disclosure.

What is claimed is:

1. A computerized method for providing business ratings for businesses in a marketplace, the method comprising:
compiling a plurality of business attributes associated with a business entity to create a business profile for the business entity;
compiling transaction information associated with the business entity to create a business grading for the business entity;
identifying a match between the business entity and a service provider based at least partially on the business profile and the business grading of the retailer;
publishing the match; and
initiating a business relationship between the business entity and the service provider.

2. The computerized method of claim 1, wherein publishing the match comprises transmitting an advertisement to the retailer.

3. The computerized method of claim 2, wherein the advertisement is targeted to the business entity based on the business entity's business profile and business rating.

4. The computerized method of claim 2, comprising charging the service provider for the advertisement only if the initiated business relationship results in a transaction for the service provider.

5. The computerized method of claim 1, comprising receiving a target business profile from the service provider, wherein identifying the match comprises identifying business entities that meet the target business profile.

6. The computerized method of claim 5, comprising receiving a target business rating from the service provider, wherein the identifying the match comprises identifying business entities that meet the target business rating.

7. The computerized method of claim 1, wherein identifying the match comprises identifying a match based at least partially on purchase trends within the marketplace.

8. The computerized method of claim 1, wherein compiling transaction information comprises compiling objective transaction information from transaction in a managed marketplace.

9. The computerized method of claim 1, wherein initiating the business relationship comprises initiating a virtual consignment relationship.

10. A computerized method for providing business rating in an e-commerce marketplace, the method comprising:
maintaining a business rating for a marketplace player, wherein the business rating is based on objective information compiled from transactions involving the marketplace player in the e-commerce marketplace; and
providing the business rating to a requestor interested in a business relationship with the marketplace player.

11. The computerized method of claim 10, wherein the marketplace player is a retailer.

12. The computerized method of claim 10, wherein the requestor comprises an investor interested in offering a loan to the marketplace player.

13. The computerized method of claim 10, comprising creating the business rating.

14. The computerized method of claim 10, wherein the objective information is compiled from a transaction database maintained by a marketplace management system.

15. A computerized method comprising:
collecting objective transaction information from one or more transactions associated with a business entity in a marketplace; and
creating a business rating for the business entity based on at least partially on the collected transaction information.

16. The computerized method of claim 15, comprising:
collecting subjective information associated with the business entity, wherein the business rating based on the objective transaction information and the subjective information.

17. The computerized method of claim 15, wherein collecting the objective transaction information comprises collecting sales volume information.

18. The computerized method of claim 15, wherein collecting the objective transaction information comprises collecting payment time information.

19. The computerized method of claim 15, wherein creating the business rating comprises creating a four part business rating.

20. The computerized method of claim 15, comprising updating the business rating if new objective transaction information is received.

21. A computerized method comprising:
receiving a service request from a retailer;
accessing a business rating for the retailer;
identifying a service provider associated with the service request; and
communicating the service request and the business rating to the service provider, wherein the business rating is based on objective information compiled from transactions in the e-commerce marketplace involving the retailer.

22. The computerized method of claim 21, wherein the code adapted to identify the service provider is adapted to identify a plurality of service providers associated with the service request.

23. The computerized method of claim 22, comprising:
receiving responses from the plurality of service providers; and
communicating the responses to the retailer.

24. A tangible computer readable medium comprising:
code adapted to receive a financing request associated with a business entity;
code adapted to determine a term for the financing request based on a business rating for the business entity, wherein the term is at least partially based on objective transaction data for the business entity; and
code adapted to communicate the term to the business entity.
